(19) United States
(12) Patent Application Publication
(10) Pub. No.: US 2024/0198841 A1
(43) Pub. Date: Jun. 20, 2024

(54) DATA STORAGE DEVICE IN A VEHICLE, METHOD AND VEHICLE

(71) Applicant: AUDI AG, Ingolstadt (DE)

(72) Inventors: Hendrik GRONAU, Ingolstadt (DE); Tobias ROSS, Ingolstadt (DE)

(73) Assignee: AUDI AG, Ingolstadt (DE)

(21) Appl. No.: 18/502,381

(22) Filed: Nov. 6, 2023

(30) Foreign Application Priority Data
Dec. 15, 2022 (DE) 102022133402.3

(51) Int. Cl. B60L 53/66

(52) U.S. Cl. CPC B60L 53/66

(57) ABSTRACT

A data storage device in a vehicle including a storage medium for data; and an interface for data transfer. The data storage device is installed in the vehicle and the storage medium is a network-connected storage. The data storage device extends a home network and/or an office internal network to the vehicle and the data storage device is accessible from outside the vehicle after a user has been authenticated.

### FIELD

The invention relates to a data storage device in a vehicle, a method and a vehicle.

### BACKGROUND

Vehicles are equipped with data storage devices to process data (control interventions, multimedia, navigation, vehicle status, etc.). However, the storage capacity is very low compared to, for example, external storage media outside the vehicle, such as in a home or office network.

However, especially in the multimedia sector, there is a need to connect external storage devices to the vehicle in order to be able to play movies or music while driving. Due to automated driving and virtual reality applications (VR), the number of multimedia applications and thus the storage requirements in the vehicle will increase in the future.

Although storage hardware is installed in the vehicle, the user of the vehicle currently has no way of accessing this storage space. Furthermore, it is currently not possible to access the storage data in the vehicle from outside a home network, for example. Movies, music or other data must be stored on a physical storage medium and made available via a physical interface in the vehicle. For example, the user's own SD cards are currently solutions for bringing their own data into the vehicle. These SD cards require SD card readers, which can be retrofitted in the vehicle if necessary or are already installed.

EP 1 610 252 A1 describes a system for controlling functions of a motor vehicle with a network communication function. In this case, a home network is expanded by a vehicle network.

DE 10 2016 212 475 A1 describes a stationary charging device and a method for operating a stationary charging device. In this case, the stationary charging device is connected to an external data network, for example the Internet and/or a home network of a building in which the stationary charging device is permanently installed. The charging device can exchange extensive data such as images, music, videos or entire libraries of such entertainment media between the data network and the motor vehicle, for example for synchronization purposes.

DE 10 2015 207 795 A1 describes a method and a device for updating software in a means of transport. Here, a data storage device can be used as a file server, a so-called Network Attached Storage (NAS) in the vehicle.

DE 11 2011 101 204 B4 discloses a system and a method for providing emergency services for a mobile vehicle, wherein a telematics unit is arranged operable in the mobile vehicle. This involves monitoring a network country code that is broadcast by a communications network provider.

DE 10 2016 214 691 A1 discloses a motor vehicle with several recording devices, which are referred to as logger units. Each logger unit can record measurement data from at least one sensor and/or communication data from at least one data bus, namely temporarily store them in a local storage. The measurement data and/or communication data represent operating data of the motor vehicle.

DE 10 2007 054 820 A1 discloses a vehicle multimedia device with a writable mass storage for storing multimedia content and with a network interface for connecting the mass storage with a vehicle-external network for supplying multimedia content to be stored in the mass storage.

DE 10 2009 045 711 discloses a data transmission, supply and charging device for a vehicle, comprising an energy storage device, a control device and a data interface, wherein the data interface is designed to receive vehicle-related data and at the same time to receive charging current for the vehicle's energy storage device via an electrical line and to transmit the data to the control device.

### SUMMARY

It is the object of the present invention to provide large amounts of data for a user in a vehicle

The object of the present invention is achieved with a data storage device in a vehicle. The data storage device according to the invention has a storage medium for data and an interface for data transfer, wherein the data storage device is installed in the vehicle and the storage medium is a network-connected storage, wherein the data storage device extends a home network and/or an office-internal network to the vehicle and the data storage device is accessible from outside the vehicle after a user has been authenticated.

In this context, a network or net is understood to mean a communication network that is suitable for data transfer or data exchange. The term “network-connected” means that the storage medium of the data storage device can be connected to one or more networks. Preferably, a direct connection takes place, namely without an intermediate instance in the network.

Vehicle users often want to have films, music and pictures with them, even on longer journeys. Due to autonomous driving, there is an increasing need to use the data not only at the destination, but also while driving. But autonomous driving also enables new applications or use cases in a professional environment. For example, there is a need to prepare appointments, edit documents or sketch ideas while driving. These applications require secure data processing and handling for private and business vehicles. The aim here is to manage, secure and protect vehicle users' data, regardless of where the data is accessed, namely in the vehicle or from outside the vehicle. This access, regardless of the user's location, can be done via authentication. This means that the user can access the data storage device from anywhere in the world. Remote access can therefore be provided for users outside the vehicle. The security of the data has the highest priority, so that suitable authentication methods are used to access the data.

It can be provided that the data storage device is designed as a NAS data storage system.

The data storage of the data storage device can be provided as a network-attached storage (NAS). A data storage device that is connected to a network (e.g. a home network or the office network) can be understood as Network Attached Storage or NAS for short. NAS systems are connected directly to the network and operate autonomously. The general network can be the Ethernet-based LAN (i.e. wired connection) or a WLAN (i.e. wireless connection). A NAS system is therefore a data storage device or a storage device that is connected to a network and allows authorized network users (individuals or employees) to store and retrieve data. The data storage device is thus a central location for data storage for users. The hard drive storage of the data storage device and all files on it are available across the network and can therefore be accessed from all devices and computers in the network. The storage or storage medium or NAS system can be used as a private cloud in the office or at home. The data storage device is faster to operate, less expensive and offers the benefits of a public cloud locally or in-vehicle while allowing comprehensive control over the data.

Regardless of its type of drive and equipment, a vehicle can be equipped with a mobile NAS system, i.e. a storage on which data can be stored securely.

The data storage device preferably has one or more hard drives as data storage. The size of the storage space differs significantly from the SD cards used today. The hard drives of the data storage device can store large amounts of data. For this purpose, the hard drive or the system of hard drives in the form of a physical storage in the vehicle has a storage capacity of approximately one tera-byte, preferably several tera-bytes or even significantly higher storage capacities, which will also be available on the market for storage media in the future.

The data storage device provides a vehicle-side network storage medium and is therefore an in-vehicle network-connected storage. The data storage device provides a means for storing personal media files for the user.

Furthermore, the interface of the data storage device can be designed as a data transfer interface or data exchange interface, preferably as a data exchange interface. A data transfer is understood to mean data transport in at least one direction of a data connection. Data exchange is data transport in both directions (bidirectional). Data transfer can be carried out wirelessly or wired.

The data storage device is preferably permanently installed in the vehicle, namely it is part of the vehicle. For example, it can be installed in the glove compartment, in the trunk or in another suitable location. The installation location of the data storage device is selected according to the geometry of the existing vehicle model and is preferably mechanically protected with damper elements so that particularly effective protection of the data is achieved in the event of an accident.

A rack construction for the design of the data storage device is also possible, in which one or more hard drives or the entire data storage device can be removed. In particular, it is ensured that this is only possible with prior authentication. Otherwise, for example, an alarm function can be activated, which is preferably audible or visible in the vehicle and/or on an application.

Furthermore, the data storage device is advantageously adapted to the environment of a vehicle. A vehicle is increasingly exposed to vibrations, shocks caused by uneven road surfaces, temperature fluctuations, humidity, etc. Therefore, the data storage device is adapted and protected according to the harsh environmental conditions. No data storage devices from an office environment should be used. Rather, the data storage device is adapted for use in a vehicle. In this way, a longer service life of the hard drives and thus data security is guaranteed. One of the measures for installing the data storage device within the vehicle are damper elements and adapted housing shapes.

In one embodiment it can be provided that the data storage device can be connected to a plurality of external data sources. An external data source is a data source that is not permanently installed in the vehicle. In contrast, the data storage device is permanently installed in the vehicle. The data source can be outside the vehicle. It is also possible for the data source to be located in the vehicle as a mobile device. The characteristic of an external data source is that it is not permanently installed in the vehicle. The external data source can be a device or be present as software, for example in the form of an external data storage such as a cloud or a server or the Internet. The external data source can be used independently of the vehicle. In other words, an external data source can be any data storage, data network or device that is not permanently installed in the vehicle, such as a smartphone, the Internet or a cloud server. In the following context, a dashcam is also viewed as an external data source because it is an optional device in the vehicle and can also be uninstalled.

It can advantageously be provided that the data storage device can be directly connected to an external data source. In this context, direct means that no further functional modules of the vehicle are required. The data storage device can thus independently establish a data connection via the intended interface or data interface of the data storage device. For this purpose, the data storage device has its own operating system with its own processor. In this way, it is possible for the data storage device to be used independently as its own data storage device. The data storage device can provide storage space with individual access options for the user. Furthermore, the data storage device can be used to provide its own WLAN network within the vehicle in order to establish a wireless connection between one or more data sources and the data storage device. The data storage device is also accessible from external devices and data sources. In other words, a mobile cloud is provided that can also be used from outside the vehicle. A user can access this cloud preferably via a wireless connection. If the vehicle is connected to a charging socket, a data connection for data transfer or data exchange can also be provided via this connection or via an additional connection on the charging socket. Overall, the interface of the data storage device is designed at least for wireless data transfer and optionally also for wired data transfer or data exchange. A combination of wireless communication and wired communication within the vehicle is also possible according to an exemplary embodiment of the data storage device. In this case, a user in the vehicle can optionally connect to the interface with a cable.

In a further exemplary embodiment it is provided that the data storage device can be used as an extension of an external data storage or as a backup of external data.

External data means data that arises outside the vehicle, e.g. data from the Internet, data from the home network, data from the office network, data from external devices in and outside the vehicle, etc. External data also includes user data that is generated on external devices in the vehicle, such as a notebook. This data is external because the user has not established a connection to the device via a radio connection or a wired connection to the vehicle. The user uses his terminal regardless of vehicle connectivity. External data can also be understood as images from a camera or dashcam, which are made available to the user in digital form while driving. In contrast, internal data of the vehicle is understood to mean data that is relevant to the driving operation and function of the vehicle, such as data in the control units, data for controlling the infotainment system, etc. In this context, these internal data are not taken into account in the present invention and its exemplary embodiments.

The data of one or a large number of vehicle users can be very diverse. Multiple users can preferably access the data storage device at the same time. The location of the users should not be restricted. This means that one or more users can be outside the vehicle while at the same time one or more users are inside the vehicle. If all these users have access, due to their authentication and for external users due to the accessibility of the vehicle within the radio network or satellite network, all users can work with the data storage device at the same time. Data can be stored and/or retrieved from there or synchronization processes can also be performed to compare data.

The user has his own server in the vehicle. This server can be used as a private cloud. The vehicle thus becomes part of the user's overall network.

The data storage device proposed can easily extend the home and/or office network to the vehicle. The vehicle therefore becomes an integral part of the home and/or office data network The proposed vehicle data storage system can be used as an extension of conventional storage media inside and outside the vehicle. For example, a user can create content in the vehicle, for example while driving or while stationary (e.g. content creator). For such a situation, the vehicle's data storage device can provide a buffer storage for the content created along the way. This content can, for example, be (raw) recordings of the driving itself, such as on off-road trails or race tracks, or content that is created independently of vehicles. This content can be uploaded to the data storage device via the interface of the data storage device in the vehicle directly, for example from a smartphone, a camera, for example a camera for 360° recordings, a dashboard camera, from the vehicle's own on-board cameras or other WLAN-enabled devices on the data storage device and can be provided to other devices within and/or outside the vehicle, ie in the vehicle network, for example a cutting station or cutter station. At the same time, the data can be uploaded/downloaded and synchronized. The synchronization can preferably take place via vehicle antennas with the station at home/in the office (cloud synchronization). Synchronization via the vehicle's existing antennas ensures signal quality and reduces battery drain on mobile devices.

The data storage device is particularly suitable as a temporary storage or buffer for regions where a mobile data connection to the cloud or to external data storage is not reliably available, is too expensive, too insecure and/or too slow.

The data storage device can also serve as a backup or data copy of the home network in order to protect data, for example from a house fire. The data storage device can also be used for data transport if it is necessary to transport large amounts of data independently or outside of the Internet. For this purpose, the data storage device can be loaded via its interface, which is connected to another interface on the opposite side or a charging station, charging socket or wallbox or data charging connection, as well as via the WLAN on site.

In a further exemplary embodiment it is provided that the data storage device has an interface for a charging station.

Charging stations are commonly used for electric vehicles and/or hybrid vehicles. Data can also be transmitted via the charging station via wired means, such as via charging cables or data cables and/or via wireless connections.

For example, the vehicle can be connected to the (home) network at the home charging station or the home charging socket via the charging cable and/or the WLAN (repeater) of the charging station. From a network perspective, the charging station acts as a switch. The vehicle is connected wired or wirelessly; a combination of connections is also possible. For the wired connection, the charging cable is technically used as a gigabit network/LAN cable. The wireless connection can also be done via a WiFi connection. The charging station can then be used as a mesh repeater or access point.

The data storage device or NAS system can handle large amounts of data and provide multiple users with access to data at the same time. The data storage device also makes this data available in the vehicle by temporarily buffering it in the vehicle's own data storage—and mirroring the data or files makes this possible. By using high-capacity hard drives and caches in the vehicle's data storage device, even large amounts of data can be made accessible, in a mobile and quick way to the user anywhere, regardless of their current mobile data connection. If there is a stable and fast data supply at the home charging station or any charging station or home charging socket, the data can then be compared and updated again with the network. Thus, the data storage device helps achieve consistent access to and provision of data across all data structures and jurisdictions.

In a further variant, the vehicle can, for example, be permanently connected to an external data network or an individual device outside the vehicle via mobile data via remote access to the respective host name.

Authentication can be carried out individually by the user, for example via a PIN, password, fingerprint, biometric data or similar. Double or triple authentication can also be provided to increase data access protection. Furthermore, the authentication can also be combined with identification data of the vehicle or vehicle identification or vehicle key data, so that double authentication takes place automatically through the combination of individual authentication and a vehicle identification (ID). The authentication can be done digitally or with digital means in combination with other authentication options, for example via sensors, etc.

In a further exemplary embodiment it is provided that the data storage device can be controlled via a digital application.

The data storage device can be controlled and managed via an application or a software program, for example on a mobile terminal. The application can control various functions of the vehicle, including access and organization of data in the data storage device. The application is preferably provided by the vehicle manufacturer, which ensures compatibility between the application, installed on a terminal, and the vehicle.

In a further exemplary embodiment it is provided that the data storage device has a synchronization function.

The proposed synchronization function refers to the synchronization of data. External data can be synchronized with the data in the data storage device. This synchronization can be done automatically, for example at preset times or when necessary, for example by activation by the user of the vehicle. Furthermore, the vehicle can also automatically start the synchronization function if, for example, based on navigation data in the vehicle, it is determined that the vehicle will soon have reached its destination. In this way, the latest status of the internal data processing in the data storage device can be updated on an external storage medium, for example a server in the office building, with the new data from the data storage device. In this way, a backup of the data storage device is created on the server in the office building. One can then continue working with the data seamlessly.

For example, local offline synchronizations can be carried out via an application. These can be understood as cloud services. The data storage device can be accessed like a network drive. For example, through a currently familiar user interface for managing files.

The data storage device in the vehicle functions as a buffer storage and provides or hosts the files provided (for the trip) to the participants, preferably registered participants, in the vehicle's network. The connected devices or instances as data sources in the vehicle environment can be understood as a network or vehicle network. With the help of the vehicle network, for example, web connections for jointly editing data (e.g. SharePoint files) can be edited live and without delays by multiple users in the vehicle. For example, the user can also make a set of presentations “offline available” in analogy to his playlist. Likewise, music playlists can also be provided directly to the vehicle infotainment system, even offline. In this way, the conventional SD card slots can be replaced or improved. The data storage device can be used as a media server and send or stream media content, for example in mp4 and mp3 format, to the devices in the vehicle. Devices in the vehicle can be smartphones, tablets, laptops, notebooks in the vehicle's WiFi network or the occupants' screens themselves. The same applies to audio books provided via Internet services (e.g. Audible, Spotify or other services) that can be integrated and downloaded.

In a further exemplary embodiment it is provided that the data storage device has a wake-up function.

There may be situations where data synchronization between the vehicle and the fixed infrastructure in a building has not been carried out. Then the most current data could be in the data storage device in the vehicle. If the user of the vehicle still wants to use the most current data, he can activate a wake-up function of the data storage device to supply the data storage device in the vehicle with electrical energy from the vehicle in order to then access the data in the vehicle from outside the vehicle. The wake-up function can also be used to send relevant data as a backup from the user's office or home to the vehicle, even though the vehicle is currently parked and no use of the vehicle is planned for a next trip.

Future vehicles will tend to require larger data storage/hard drives. In a further embodiment, the data storage device according to the invention and its developments can be made available to the internal storage management of the vehicle in addition to the actual storage. Thus, in one embodiment, the data storage device can be temporarily made available to the user, for example upon request and also when required for internal driving functions. This means that in one embodiment the data storage device is provided to both the vehicle and the user. This means that free storage capacities on the storages can also be used by the user as an option or as a function on demand in the form of a data storage system, provided that the data storage is not made available to the driving system and is currently unused.

The user can also optionally provide larger storage capacities (hard drives) if it is foreseeable that he will use the data storage system and its function more often or more intensively.

Furthermore, additional services may result from the provision of the data storage system. For example, mobile data volumes or flat rates can be offered to the user.

Furthermore, the object of the present invention is achieved with a method for using a data storage device in a vehicle. For this purpose, the method according to the invention includes providing a storage medium and providing an interface for data exchange with the vehicle environment. Furthermore, the method according to the invention includes operating the data storage device in the vehicle and connecting the storage medium to a network, wherein the data storage device extends a home network and/or an office-internal network to the vehicle and the data storage device is accessible from outside the vehicle after a user has been authenticated.

In one embodiment, the method may provide the connection of the data storage device via the interface to an external data source. For this purpose, data connections can be connected to the interface. These data connections can be wireless and/or wired. The data connections are preferably designed bidirectionally for data exchange.

The motor vehicle can be understood as a means of transport and includes electric vehicles, hybrid vehicles, combustion vehicles. A vehicle is provided with a data storage device, preferably with a mobile NAS (Network Attached Storage). The vehicle will therefore be equipped with an individual, intelligent storage on which large amounts of data can be stored securely.

The invention includes the data storage device in the motor vehicle. The control device can have a data processing device or a processor device which is designed to perform an embodiment of the method according to the invention. For this purpose, the processor device can have at least one microprocessor and/or at least one microcontroller and/or at least one FPGA (Field Programmable Gate Array) and/or at least one DSP (Digital Signal Processor).

The processor device can also comprise program code, which is designed, upon execution by the processor device, to perform the embodiment of the method according to the invention. The program code can be stored in a data storage of the processor device. A processor circuit of the processor device can have, for example, at least one circuit board and/or at least one SoC (System on Chip).

The invention also includes developments of the method according to the invention, which have features as already described in the context of the developments of the motor vehicle according to the invention. The corresponding developments of the method according to the invention and its exemplary embodiments are to be used in accordance with the characteristics of the data storage device.

The motor vehicle according to the invention is preferably designed as an automobile, in particular as a passenger car or truck, or as a passenger bus or motorcycle.

As a further solution, the invention also comprises a computer-readable storage medium, for example in the form of one or several hard disks, comprising commands which, when executed by a computer or a computer network, cause it to execute an embodiment of the method according to the invention. Hard drives represent a non-volatile storage medium. It thus can be provided that a portion of the storage medium is embodied, for example, at least partially as a non-volatile data storage (such as a hard drive, a flash storage and/or as an SSD—solid state drive) and/or at least partially as a volatile data storage (such as a RAM—random access memory). The storage medium is installed in the vehicle and can also be connected to a so-called app store server on the Internet, for example. An application to control the data storage device and the data storage can also be made available via an Appstore server. A processor circuit with at least one microprocessor can be provided by the data storage device as a computer or computer network. The commands can be provided as binary code or assembler and/or as source code of a programming language (such as C).

The invention also comprises the combinations of the features of the described embodiments. The invention therefore also comprises implementations that each have a combination of the features of several of the described embodiments, provided that the embodiments have not been described as mutually exclusive.

### BRIEF DESCRIPTION OF THE FIGURE(S)

Exemplary embodiments of the invention are described hereinafter. In particular:

FIG. 1 shows a data storage device in a vehicle according to an embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

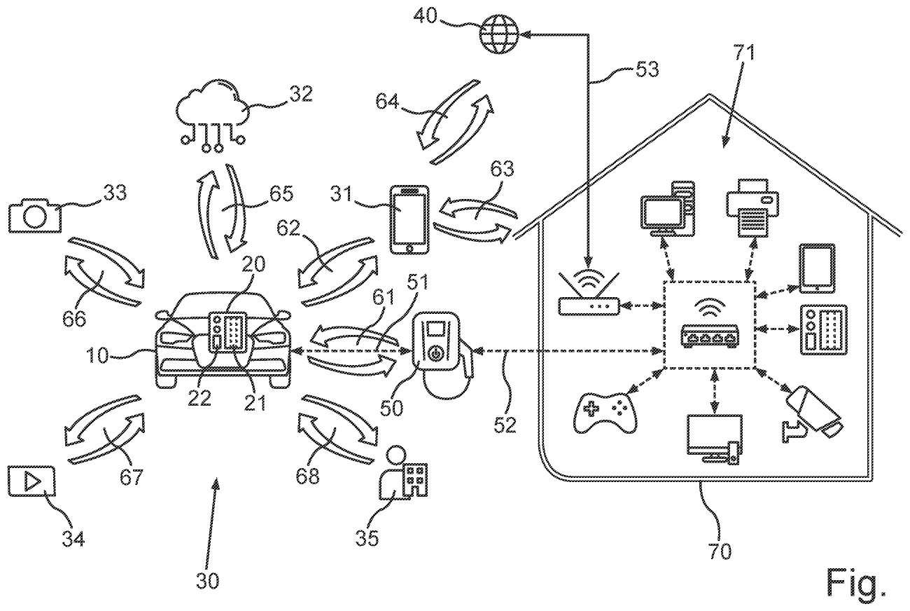

FIG. 1 shows an exemplary embodiment of the present invention with a vehicle 10 that has a data storage device 20, also called data storage system 20 in this case. The data storage device 20 is designed as a NAS system. The data storage device 20 has one or more storage media 21 and at least one interface 22. For a direct connection to the environment 30 of the vehicle 10, the data storage device 20 has at least one interface 22. This interface 22 can be a wireless interface and/or a wired interface.

Furthermore, the data storage device 20 can be connected to external data sources (31-35, 40, 50, 71) in a vehicle environment 30 via one or a plurality of data connections 51, 52, 61-68. Data can be exchanged with terminals 31, with services 34 and/or the Internet 40. These are understood as data sources 31-35, 40, 50, 71. For example, via a charging station 50, for example an installed wall box, which is preferably equipped with a switch function, one or more data connections 50, 52 can be established from the vehicle 20 to a building 70 with a home network 71 and/or office network 71 or a private home network and/or company network 71. This network 71 can also be connected to the Internet 40 via another data connection 53.

The symbolic arrows shown on the data connections 51-53 as well as internal networking in the building show that these are preferably bidirectional data connections, namely downloading and uploading data is possible via these data connections. Additional data connections 61-68 may be present in the vehicle environment. The data connections 61-68 in the vehicle environment 30 are, for example, wireless data connections. These are also designed bidirectionally to enable data to be transmitted from the vehicle to a device or to the cloud and also in the other direction from external data storage to the vehicle 10. This is possible via appropriate data interfaces in the vehicle 10. A user in the vehicle can therefore use various digital applications 31-35 while in the vehicle 20. For example, the user may have access to a cloud 32 via the data storage device 20. He does not need a hotspot on his mobile terminal 31 for this, since the data storage device 20 can establish a connection directly with the cloud 32 via the interface 22.

The interface 22 can, for example, use the data connection 62 to exchange data with a mobile terminal 31, such as a smartphone or a tablet. Furthermore, the data storage device 20 can be connected via the interface 22 independently of a connection to the mobile terminal with the cloud 32 and the associated services, with a dashboard or a vehicle camera 33, with social media and networks (social media) 34 and with a work platform 35 for working on the vehicle.

The data storage device 20 can be equipped with several data storages or hard drives as storage medium 21. These data storage devices can also be combined into a logical volume in a RAID (RAID=Redundant Array of Independent Disks).

A RAID system is used to organize multiple physical storage devices into a logical drive. Such a logical drive increases reliability and allows greater data throughput than a single physical storage medium. This means that greater capacity, security and speed are possible with two or more hard drives.

Furthermore, it is possible to upload all of the data from the home or office network 71 to the data storage device 20 in the vehicle via the interface 22. If the data from the home or office network 71 is also mirrored onto the hard drive or hard drives in the vehicle 10, this increases the performance, redundancy and reliability of the data. This data is thus stored centrally in the vehicle 10 and can be made available to other applications or devices via the at least one interface 22. The data storage device 20 thus represents a central unit that can be used as a cloud.

The proposed data storage device 20 is an intelligent storage device in the vehicle 10 and is therefore part of the home and/or office network 71. All files of family or colleague, from important documents to valuable photo, music and video collections, can be stored on the data storage device 20. The files can be accessed via a web browser or mobile apps (e.g. offered by the vehicle manufacturer) and various services of the data storage system 20 can be used via the Internet.

Overall, the examples show how a mobile, private cloud can be provided. Overall, by integrating the data storage device 20 into an overall network, seamless access to the data can be provided for the user.

### LIST OF REFERENCE NUMERALS

10 vehicle
20 data storage device or data storage system, for example NAS system
21 storage medium
22 interface
30 vehicle environment
31 mobile device, e.g. smartphone, tablet, notebook
32 cloud and services
33 dashboard or vehicle camera
34 social media application, e.g. from the Internet
35 possibility of working in the vehicle, e.g. via notebook
40 Internet
50 charging station, e.g. wall box as a switch
51-53 data connections
61-68 data connections, e.g. wireless data connections
70 buildings
71 home network and/or office network or private home network and/or company network

1. A data storage device in a vehicle comprising:
a storage medium for data; and
an interface for data transfer;
the data storage device is installed in the vehicle and the storage medium is a network-connected storage,
wherein the data storage device extends a home network and/or an office internal network to the vehicle and the data storage device is accessible from outside the vehicle after a user has been authenticated.

2. The data storage device according to claim 1, wherein the data storage device is connectable to a plurality of external data sources.

3. The data storage device according to claim 1, wherein the data storage device is usable as an extension of an external data storage or as a backup of external data.

4. The data storage device according to claim 1, wherein the data storage device comprises an interface for a charging station.

5. The data storage device according to claim 1, wherein multiple users can access the data storage device simultaneously.

6. The data storage device according to claim 1, wherein the data storage device is controllable via a digital application.

7. The data storage device according to claim 1, wherein the data storage device comprises a synchronization function.

8. The data storage device according to claim 1, wherein the data storage device comprises a wake-up function.

9. A method of using a data storage device in a vehicle comprising
providing a storage medium; and
providing an interface for data exchange with the vehicle environment;
operating the data storage device in the vehicle; and
connecting the storage medium to a network, wherein the data storage device extends a home network and/or an office internal network to the vehicle and the data storage device is accessible from outside the vehicle after a user has been authenticated.

10. A motor vehicle having a data storage system according to claim 1.

11. The data storage device according to claim 2, wherein the data storage device is usable as an extension of an external data storage or as a backup of external data.

12. The data storage device according to claim 2, wherein the data storage device comprises an interface for a charging station.

13. The data storage device according to claim 3, wherein the data storage device comprises an interface for a charging station.

14. The data storage device according to claim 2, wherein multiple users can access the data storage device simultaneously.

15. The data storage device according to claim 3, wherein multiple users can access the data storage device simultaneously.

16. The data storage device according to claim 4, wherein multiple users can access the data storage device simultaneously.

17. The data storage device according to claim 2, wherein the data storage device is controllable via a digital application.

18. The data storage device according to claim 3, wherein the data storage device is controllable via a digital application.

19. The data storage device according to claim 4, wherein the data storage device is controllable via a digital application.

20. The data storage device according to claim 5, wherein the data storage device is controllable via a digital application.
